(19) United States
(12) Patent Application Publication
(10) Pub. No.: US 2011/0246391 A1
(43) Pub. Date: Oct. 6, 2011

(54) BOND ISSUE INFORMATION MANAGEMENT AND DISTRIBUTION SYSTEM

(76) Inventor: Mary Patricia HENDERSON, Healdsburg, CA (US)

(21) Appl. No.: 13/080,414

(22) Filed: Apr. 5, 2011

Related U.S. Application Data
(60) Provisional application No. 61/341,701, filed on Apr. 5, 2010.

(51) Int. Cl. G06Q 40/00

(52) U.S. Cl. 705/36 R

(57) ABSTRACT

Disclosed is a new bond issue information management and distribution system and methods of using the same in which users, including bond issuers, investors, underwriters, and other financial intermediaries may participate regardless of affiliation, or lack of affiliation, amongst them. The disclosed system and method provides a central clearinghouse for information regarding new issue bonds and provides open access to such information. Also disclosed is a system and method for distribution of advertisements regarding new issue bonds.

### RELATED APPLICATIONS

Priority is claimed from provision application U.S. Ser. No. 61/341,701, filed Apr. 5, 2010, now pending. The entire specification and all disclosures of the provisional application referred to are hereby incorporated by reference to provide continuity of disclosure.

### BACKGROUND OF THE INVENTION

Although approximately half the municipal bond secondary market is now traded directly online, there is no active online access for individual investors to the primary bond market. There has not been a successful effort to date to provide for access to the entire primary new issue market, except for on a single case effort by broker-dealers on behalf of their own clients and deals only.

A bond issuer sells its bonds in the primary market through brokerage firms to various willing purchasers, including individual investors and institutional investors, such as banks and mutual funds. An issuer does not directly sell its bonds in the primary market. Instead, the issuer sells its bonds through brokerage firms that it selects to participate in the initial bond sale. Collectively, such firms are the underwriting syndicate.

To buy a new issue bond, investors generally must have an account either with one of the participating brokerage firms or with another firm that can place an order through a participating brokerage firm during the underwriting period. Information, disclosures, and preliminary statements regarding new issues has also traditionally been restricted to investors that have an account either with one of the participating brokerage firms or with another firm that can access such information through a relationship with a participating brokerage firm. In this way, information regarding new issues is not disseminated to the public at large, but is rather restricted to investors that are clients of the underwriting syndicate or clients of those firms with a relationship with the underwriting syndicate. From the point of view of the issuers, this is sub-optimal because it restricts the pool of potential investors for new issues.

Investing in new issue bonds is often complicated for small investors. Historically, individual investors have had access to information regarding new issue fixed income securities only when the individual owned a securities brokerage account at a financial institution that is a member of the underwriting team or at a firm that can place an order with the underwriters. Even when this is the case, financial institutions underwriting fixed income securities generally restrict access to new issues to the largest in-house accounts and institutional accounts. Another difficulty is that in most cases, particularly with municipal bond new issues, there is little time for the issuer to disseminate information and for the investor to review such information and conduct other due diligence. In many cases there are only days, or hours, before the actual pricing of the bonds, to contact interested investors and distribute the marketing documents. Because of these barriers, it can be difficult or impossible, as well as expensive, for individual investors to become aware of new issue fixed income securities prior to the initial sale, or to become educated and updated regarding relevant disclosures.

Since new issue fixed income securities are all sold at the same price whether to institutions or individuals, it is economically advantageous for retail investors to have access to new issues during the underwriting period. Otherwise access is only in the secondary market at the prevailing market price.

In order to take advantage of an underwriting process, and pay the same low price as the largest institutions, the investor must be aware of the bond sale in enough time to do his/her own due diligence and review the preliminary official statement and other disclosures. The investor must also be aware of any changes to the new issue disclosures leading up to the initial sale. Accordingly, the informational restrictions noted above are also suboptimal from the point of view of the investor. If an investor is able to access and assess information regarding new issues in a timely fashion prior to the initial sale, the investor may be able to determine if the new issue is a suitable investment and arrange to participate in the issue.

Issuers also have an economic interest in advertising new issues as widely and as economically as possible. Increasingly, issuers have a political and public relations interest in making new issue bonds available to the public, and to individual retail investors in particular. Various government regulating bodies or self-regulating authorities may also require broad dissemination of information relating to new issue bonds, including in particular to individual retail investors.

Issuer's advertisements to retail investors have generally been limited to radio and print ads (aka tombstone announcements). Except for the largest of issuers, these mediums have been prohibitively expensive.

Issuers sometimes provide individual investors with the opportunity to place orders to purchase bonds before other investors (such as commercial banks and other institutional investors). This early order period is known as the “retail order period”. A benefit of the retail order period is that it provides individual investors with a chance to place orders prior to institutional investors. The retail order period generally occurs one or two days prior to the bond sale date. Broad based, timely, and updated dissemination of information is crucial for individual investors to take advantage of a retail order period.

Recently, many issuers have requested early retail order periods in order to provide additional time prior to the sale date to locate and educate individual retail investors. An early order period provides potential retail buyers priority access to purchase bonds. Generally, issuers locate retail investors through client accounts of the various financial institutions that will underwrite the bond issue.

### BRIEF SUMMARY OF THE INVENTION

The invention relates to a system and method for aggregating investor demand for, information regarding, and advertisements for new issue fixed income securities, and identifying suitable offered securities to meet that demand. The invention is open access with respect to all users, including the bond issuers, the investors, and the underwriters and other financial intermediaries, regardless of affiliation or lack of affiliation among these market participants.

A primary object of the invention is to aggregate new issues information regardless of the composition of the underwriter syndicate of the new issues. Another primary object of the invention is to aggregate retail investors' demand for new issues regardless of the investors' affiliation or lack of affiliation with the members of a new issues' underwriting syndicate. Such aggregation can provide investors access to a wide range of new issue information not previously available.

An object of the invention is to provide a centralized point of access to new issue information during the underwriting period of new issue fixed income securities. A further object of the invention it to provide individual investors with direct access to issuers and underwriters.

A further object of the invention is to allow interested investors to search, identify, review, research, and monitor new issues prior to initial sale. A further object of the invention is to alert individual investors of new issue offerings that feature characteristics pre-selected by such investors. A further object of the invention is to update investors during the underwriting period regarding changes to new issue disclosures.

A further object of the invention is to provide issuers an online advertising platform that can reach investors, including individual retail investors. A further object of the invention is to allow underwriters to provide direct access to new issue markets to all interested investors, including individual investors who do not have an account with the underwriters.

A further object of the invention is to allow issuers to announce and advertise in a cost effective manner upcoming bond sales to the general public without the audience being limited to those investors affiliated with certain underwriters or financial institutions.

A further object of the invention is to aggregate underwriters' demand for new fixed income investor clients and provide underwriters seeking such clients an opportunity to advertise to and communicate with potential new clients.

### BRIEF DESCRIPTION OF THE DRAWINGS

FIGS. 1-9 are schematic block diagrams illustrating an Internet-based computer system related to a new issue information management system.

FIGS. 10-16 are computer screen displays showing the user interface of a new issue information management system.

### DETAILED DESCRIPTION OF THE INVENTION

The following detailed description illustrates the present invention by way of example, not by way of limitation, of the principles of the invention. This description describes several embodiments, adaptations, variations, alternatives and uses of the invention, including what are presently believed to be the best modes of carrying out the invention. This description will clearly enable one skilled in the art to make and use the invention.

In the following description, for the purposes of explanation, numerous specific details are set forth in order to provide a thorough understanding of the present invention. It will be apparent, however, to one skilled in the art that the present invention may be practiced without some of these specific details.

The present invention includes various steps which will be described below. At least some of the steps of the present invention may be embodied in machine-executable instructions. The instructions can be used to cause a general purpose or special-purpose processor that is programmed with the instructions to perform the steps of the present invention. Alternatively, at least some steps of the present invention may be performed by specific hardware components that contain hardwired logic for performing the steps, or by any combination of programmed computer components and custom hardware components.

While, embodiments of the present invention will be described with reference to an Internet-based portal developed by BondUnderwriter.com for municipal fixed income securities, the method and system described herein are equally applicable to other types of new issue fixed income securities.

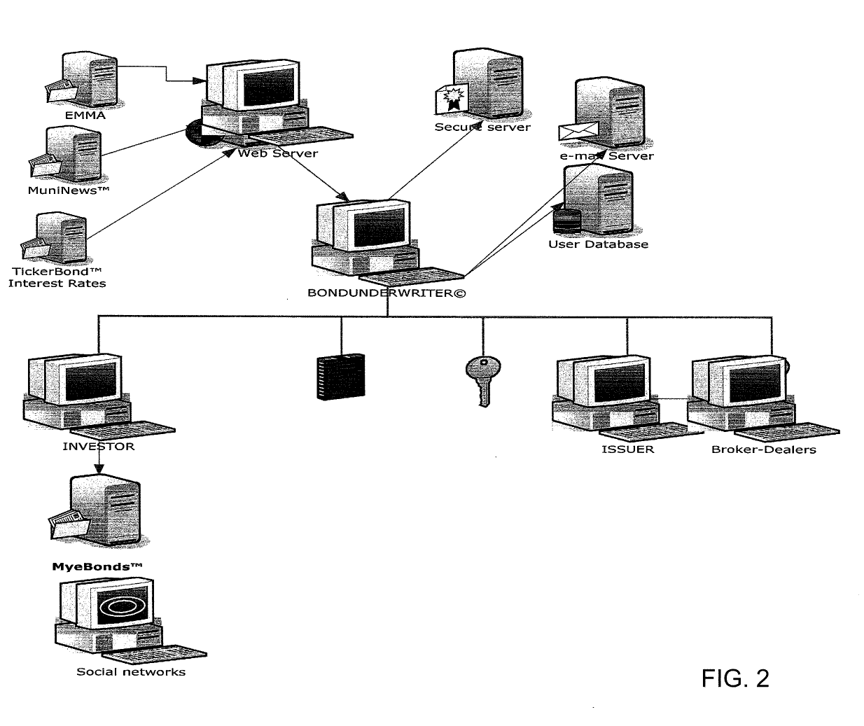

The present invention may be included within a client-server based electronic information management system operating over a computer network on separate hardware. FIG. 2 is a flow chart illustrating the client-server system used to implement the preferred embodiment of the new issue information management system.

The invention as implemented as an information management and database interface software application is integrated with other software applications utilized by a variety of different users and locations that, in combination, make up the information management and database interface system implemented on a computer system. Each part of the electronic information management system serves to facilitate the communications between issuers, investors, and other market participants in the primary bond market.

By way of illustration, buy side users include individual retail investors as well as institutional securities investors such as trust departments, fund managers, and investment managers of individual clients' accounts, who are responsible for identifying and researching new issue bonds. Sell-side users are issuers as well as their agents including broker/dealers and underwriters. Both buy-side and sell-side market participants use the electronic new issue information management system as described herein.

The invention provides for the electronic integration and distribution of new issue market information. Issuers and/or broker/dealers can manually populate information fields provided by the system or, alternatively, the information can be automatically uploaded to the system. In either case, the system distributes the new issue information to investors and other market participants using the system.

New issue information (and later, post-sale information) can be formatted for direct download into a users' compatible software application. After downloading the information, the user can review the information and conduct due diligence to evaluate the purchase of any of the bonds which make up the new issue sale.

A section of an exemplary embodiment of the current invention may provide display of new issuance information. New issuance information can be search, screened, or filtered by new issuance security characteristics such as by state of issuance and sale date. A new issuance sale includes by example a par amount, coupon rate, yield and dollar price for each security. While multiple users (issuers and their various agents) may be authorized to create a new issue database entry, preferably, only one entry for any given security may be active at any given time for the purpose of distributing new issue information.

The electronic new issue information management system can include various computer subsystems. The system's software application can be executed on computer subsystems that include a web server (or web servers) addressable at a web site on the Internet or other computer communication networks. Investors send data to and receive data from the web-based management software application over an Internet connection from a computer subsystem that is executing a compatible software application. Investors' computer subsystem can include a personal computer. Investors can access the web-based software application and database hosted on a web server by an application service provider through conventional web access controls and techniques.

Similarly, each issuer or issuer agent can send data to the system application and can receive data from the application over an Internet connection from a computer subsystem, such as a personal computer, through a conventional web browser. For all computer subsystems, hardware such as personal phones, computer tablets, or other portable and wireless devices are also contemplated.

The computer systems and subsystems contemplated by the invention include a central processing unit and a memory device. The central processors can be operative to carry out instructions for performing the various functions, for example instructions embedded in a microprocessor hardware. Data is entered into the memory by a user via a conventional keyboard or other input device by an application program interface, or via a network connection to a server computer at a location remote from the location of the computer system executing the information management application. The network connection can include, for example, a modem and/or router, a wireless communication system, a computer communication network, such as the Internet, and server computer that stores data in a database.

Memory stores instructions that cause data to be processed and to be displayed as screen displays on a conventional display monitor having a display face. The instructions include a plurality of algorithms that enable efficient management of submission of information related to new issue bonds, the indexing and storage of such information in a database, the searching, screening, and filtering of such information by users, and the dissemination of such information according to inputted criteria. The algorithms may be implemented in a variety of computer languages with results displayed via a conventional web browser or other general user interface without undue experimentation.

The present invention relates to a method and a system for aggregating, managing, and disseminating information and advertisements related to new issue bonds. The method and system of the present invention provides open access participation to both buy-side and sell-side participants.

A primary feature of the invention is that an investor is not required to have any account with any dealer, underwriter, or any other financial institution to access the new issue information. The invention provides for open access to all investors regardless of relationship or lack of relationship with any financial institution.

The invention provides methods and devices related to consolidating the primary market for new bond issues regardless of investor or issuer affiliation with financial institutions. The invention allows potential bond investors to search for, locate, review, and request additional information related to new issue bonds before and during the underwriting period. The invention also serves as an advertising portal for bond issuers with optional interactive capabilities.

Sell-Side Users

A feature of the new issue information management and distribution system is to allow an issuer to input information relating to its upcoming bond sale into pre-determined and formatted fields on a predesigned template, using a standardized electronic submission interface. The electronic submission interface can be internet based, network based, or computer-to-computer based. The input fields can include information relating to: the issuer's name, title, organizational affiliation, address, phone number, and other contact information; the state, government, corporation, or organization offering the new issue; a description of the purpose of the bond issue; the estimated size of the issue; the expected and/or actual credit ratings of the issue; the expected bond maturities to be available for purchase; the expected sale date; whether or not there will be an early order period for individual investors (retail order period), and if so the dates for investors to express interest; and hyperlinks, HTTP addresses, and URL's to relevant documents, web pages, or other information including without limitation, links to the issuer's website, the issuer's investor relations website, the underwriters' websites, the websites of all participating broker dealers, the website of the Municipal Securities Rulemaking Board (MSRB)'s EMMA System, and the bond trustee contact Information, if applicable (for invoice and payment instructions upon the successful sale of the bonds). This information will be used to create a databse with information submitted by other issuers. The database will be a listing of upcoming bond sales with information indexed according to the fields.

With the issuers' approval, its website address will also be automatically added to an investors relations directory featured on the system for registered investors to access at no charge.

Issuers can also provide PDF's, GIF's, JEG's , HTML's and other user prepared information and artwork to include in formatting an advertisement. Issuers can post advertisements to the system with varying text and images to be displayed and disseminated to buy-side users, targeting potential investors by location and investment criteria.

As used herein, all information, documents, and advertisements submitted by an issuer or its agents is collectively termed “new issue information.”

A feature of the system is to allow use by authorized representatives and agents of the issuers. Such agents could include the issuers' financial or legal advisors; the issuers' designated brokers, dealers, municipal securities dealers and other designated market agents (“dealers”); and dealers acting as underwriters, placement agents, or remarketing agents (“underwriters”) specifically for the primary offering and the issuer's financial advisor(s). As used herein, “Issuer” is understood to mean the issuer as well as each of these other sell-side participants that may be acting as an agent for the issuer.

Correctly identifying the category of information or documents being submitted and the issues or specific securities to which such document is related is crucial to populating the system's database. Use of pre-established fields assist in identifying and indexing the information. In this way issuers and their agents provide primary market information as well as related indexing information with respect to substantially all information submitted. This allows the category of the information being submitted, and the issues or specific securities to which such information is related, to be easily identified and organized in a searchable database.

The issuer field indicates the state, political subdivision, municipality, or governmental agency or authority that is raising funds through the sale of municipal securities.

The description field indicates the type and/or purpose of the bonds.

Bonds may be rated by one or more of several rating agencies, for example Moody's Investors Service, Standard & Poor's, and Fitch Investors Service Ratings. The ratings field indicates the ratings assigned by each ratings agency. Additional fields or subfields could be provided for expected ratings if no ratings had yet been assigned or if the issue is not to be rated.

A sale date field indicates the expected bond sale date, which is generally subject to change in new issues. The sale date is the day the bond's pricing and terms are locked in between the issuer and the underwriter(s). Indications of interest are generally taken prior to this date. The system indicates “sold” if the issuer has closed the order period for the issue and the bonds are no longer available during the underwriting period. If sold, the investor could review the final terms.

The maturity dates field indicates the years for each of the final maturities of the bonds to be issued. There may be serial maturities and/or term bonds requiring several fields or subfields.

The size field allows the input of the estimated Issue par amount and is displayed in millions. It is the total dollar value of all bonds offered.

A retail order period field indicates if and when the new issue may be available to individuals on a first priority basis. A retail order period is generally a 1 or 2 day period preceding the actual sale date reserved for retail orders. For instance, if there a 1 day order period scheduled and the sale date is February 24, the early order period giving individual investors priority will be on Feb 23; a 2 day order period will be for the 22nd and 23rd. The field could indicate “1” if there is a one day priority retail order period scheduled for the day preceding the sale date and a “2” if there is a two day priority retail order period. If there is no priority retail order period scheduled, the field could so indicate or simply be left empty.

The definition of retail is generally subject to each issuer but is generally defined as including individuals, financial advisors, and trust departments. An additional field or sub-field could be provided to indicate the specifics of those eligible for priority orders.

The official statement field allows issuers to upload or link to the preliminary official statement for the new issue, or the final statement if and when available. The preliminary official statement describes the proposed new issue, except for the actual pricing and final maturities. The interest rate, yields and maturities are finalized on the sale date and the bonds are awarded to the underwriter(s) by the issuer. A final official statement details the final terms and pricing of the issue and is available after the sale date but prior to the settlement date. The settlement date (closing date) is generally about 10 business days after the sale date.

An advertisement field allows the issuer to submit an advertisement to the system which will then be attached to its Listing in the Upcoming Bond Sales Section. The ad will be formatted either with 1) a self-service tool built by formatting into HTML the Bond information provided by the Issuer, using standard text and images, or 2) by manually adding an advertisement by PDF or URL containing its own copy-protected text, hyperlinks and image. The Issuer can also select to allow the search function to target potential buyers by state, zipcode, rating, purpose of the Bonds, or other investment criteria

A Tool offered that tracks the performance of an advertisement , such as how many users click on the ad or are directed to the Issuers Website or other hyperlink provided.

The above noted pre-determined fields for population by the issue are by way of example only and it should be understood that the invention can include a variety of additional fields relating to new issues.

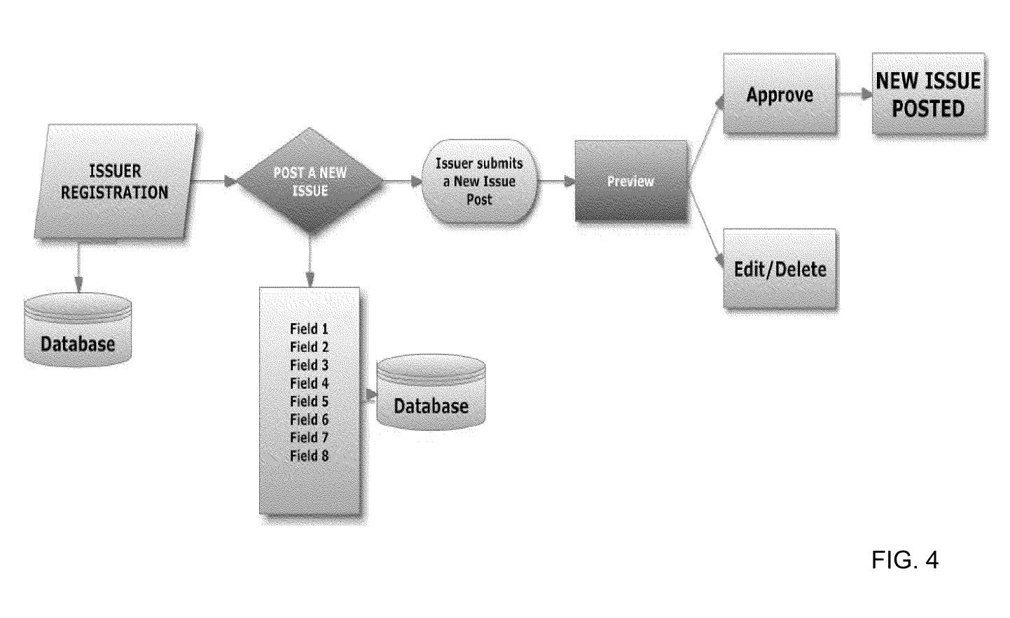

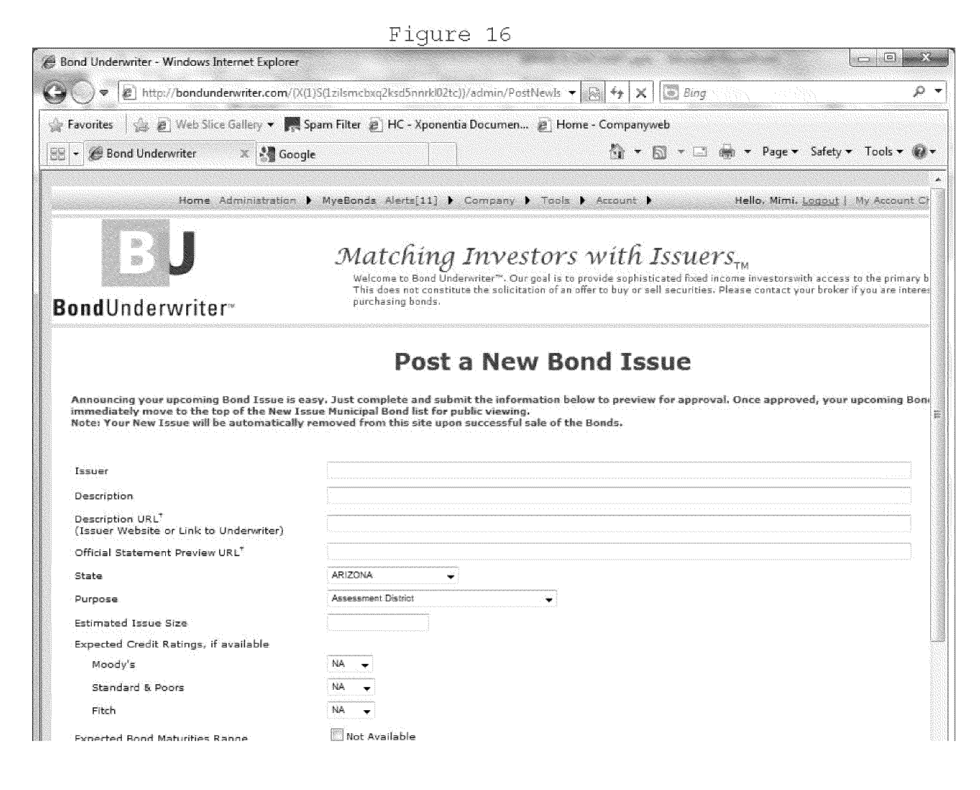

FIG. 4 includes a schematic representation of the fields used by an issuer to poser new issue information, and which is used to create a new issue information database. FIG. 16 shows an example of the pre-formatted fields that issuers can populate with new issue information.

Submission of new issue information can be restricted in whole or in part to issuers that register with the new issue information management system. A subscription or fee may also be required to submit certain new issue information or to enable certain functionalities with respect to buy-side users. For example, submission of advertisements may be restricted to only registered, subscribed, or paying issuers. Also, certain screening or notification functions may not be made available to investors for securities offered by non-registered, non-subscribed, or non-fee-paying issuers.

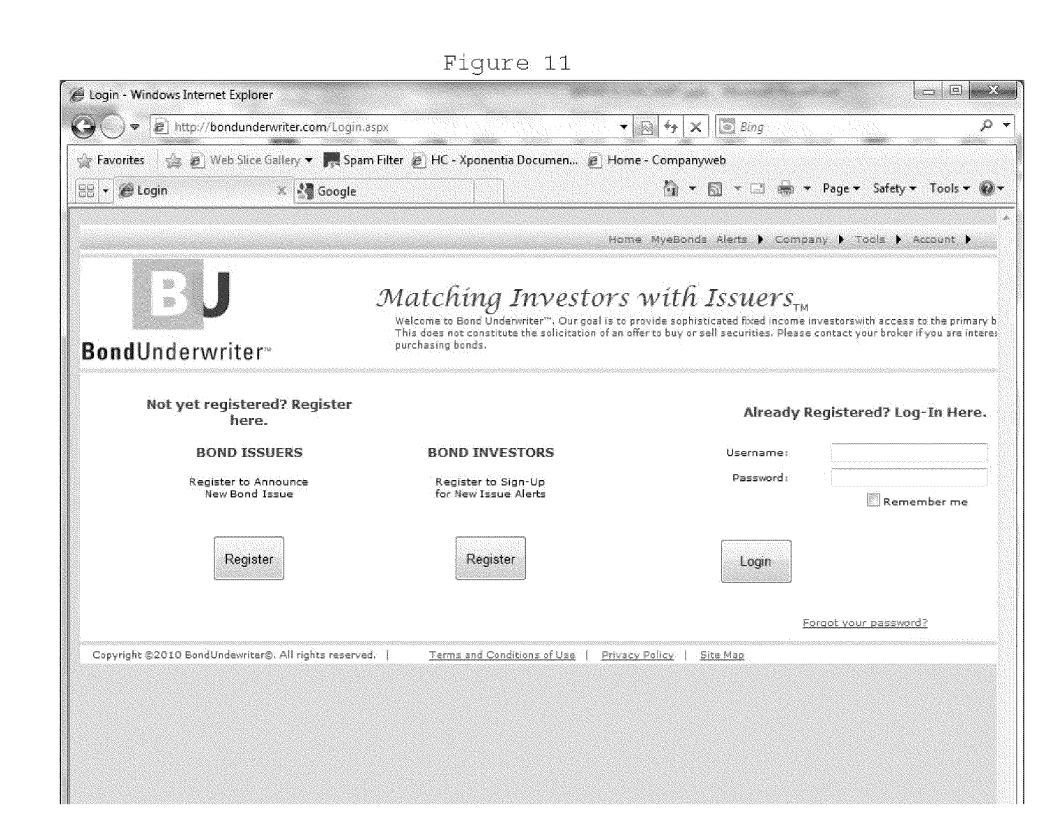

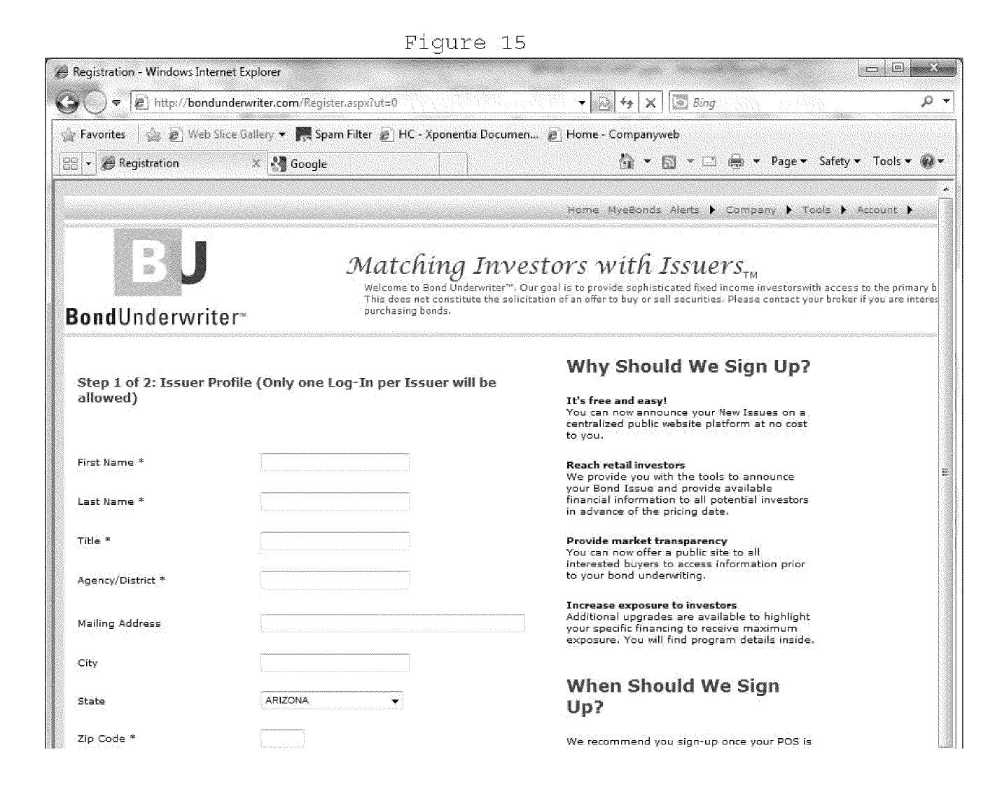

FIG. 15 shows a exemplary registration interface for a computer display. FIG. 11 shows a login interface on a computer display for registered users to login to the system.

Registration may optionally include verification procedures to affirmatively establish the account holder's authority to act on behalf of the issuer in connection with primary market disclosure submissions.

Registration is open to all issuers regardless of affiliation with financial institutions or the composition of the underwriting syndicate for the issuers' new issue bonds.

Buy-Side Users

The new issue information management and distribution system is directed to investors who wish to receive, retrieve, collect, and store information regarding new bond issues for easy monitoring, updating, and review without regard to the investor's affiliation with particular brokerage firms. The system allows investors to search a new issue information database according to a variety of criteria and identify and select new issues that correspond with the investor's investment interests.

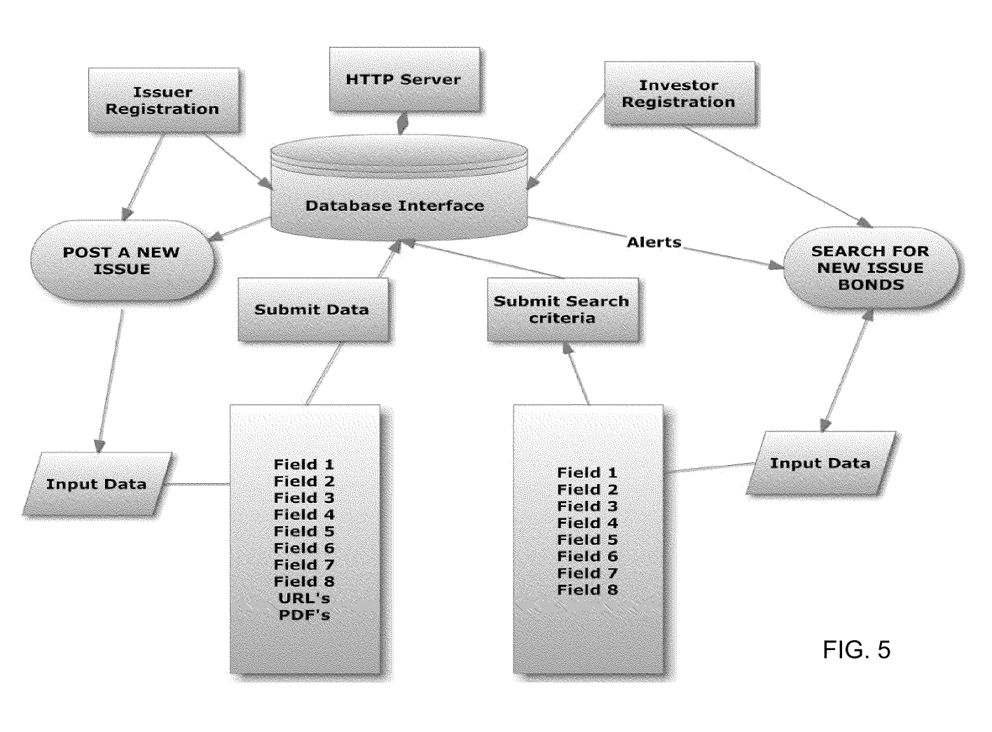

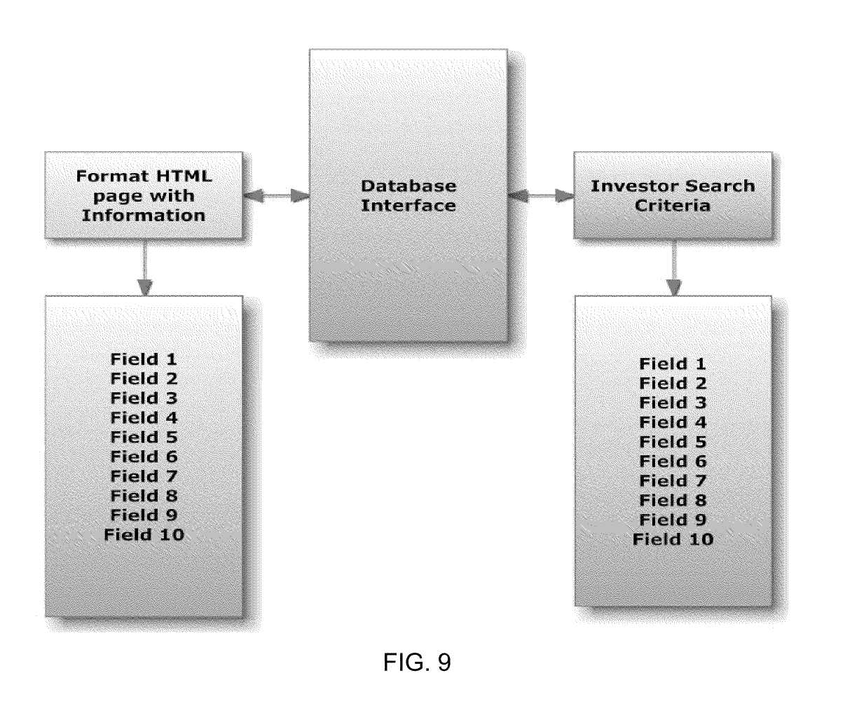

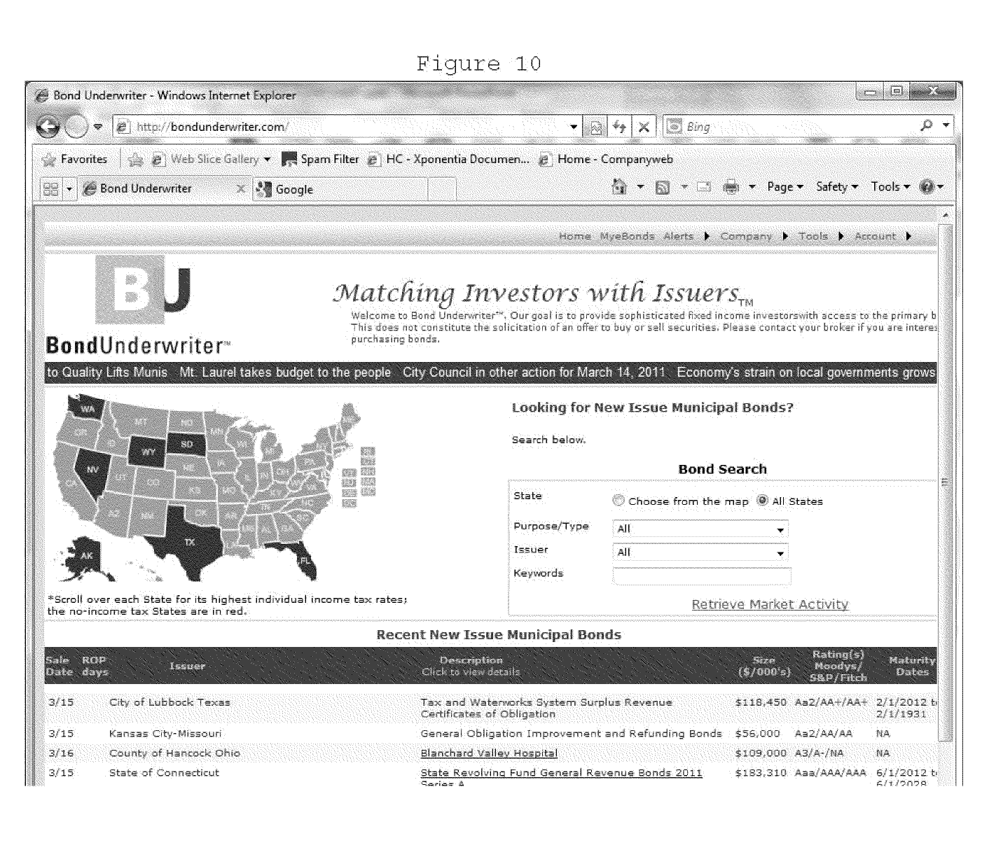

Various search criteria allow the investor to screen new issues by desired investment criteria. Search criteria could potentially include metrics associated with each input field completed by the issuer. FIGS. 5 and 9 schematically illustrate how the issuer input fields correspond to the search metric fields used by investors. However, search capabilities are optimally tailored to criteria most important to the investor. For example, investors in tax-exempt municipal bonds typically prefer to purchase bonds issued from their own state of residence for tax reasons. The system can provide for state specific identification of new issue bonds via a map interface as shown in FIG. 10. In order to find new issues by state, using the U.S. map on the interface, the user could select the state of interest from the map or from a drop down box. If the State is not an investment criterion, investors can chose to select all states to view all new issues.

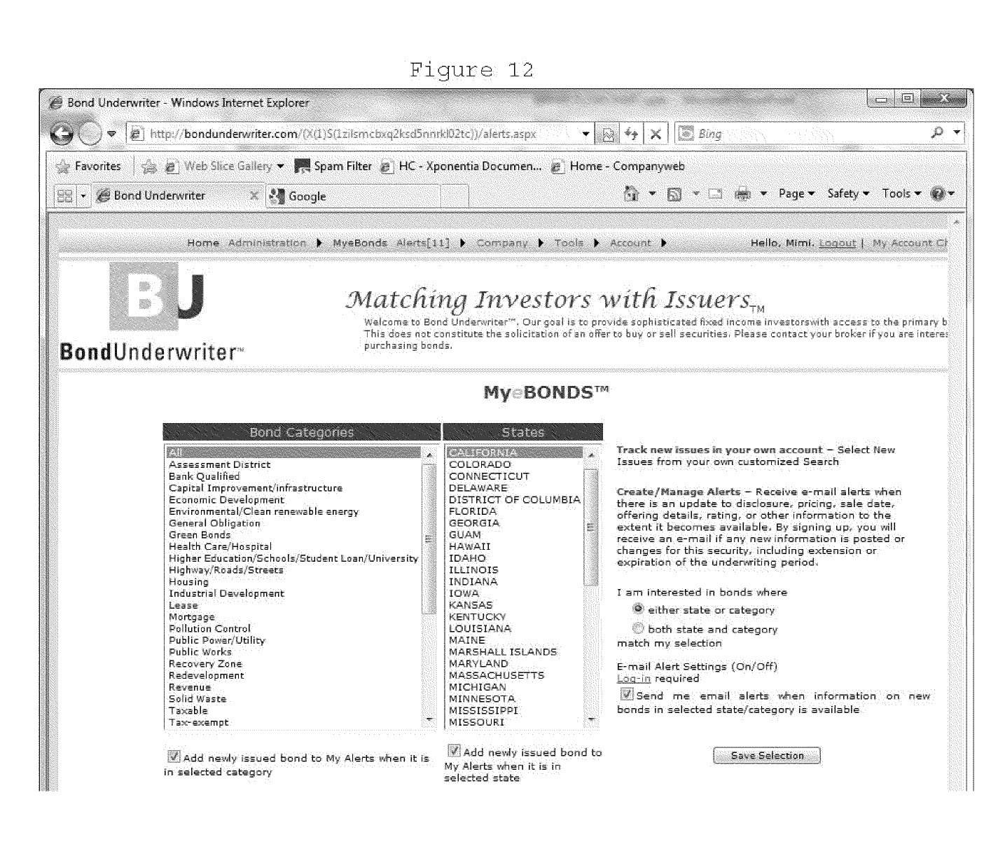

Other primary search criteria are the purpose or type of bond and the issuer of the bond, as shown in FIG. 10. Various bond categories according to purpose can be selected from a drop down box as shown in FIG. 12. Investors can also search the database by keyword as shown in FIG. 10.

Once new issues of interest are selected, the system allows investors to access some or all of the new issue information posted by the issuer, including particularly the preliminary official statement and preliminary price and yield information. The system can also provide contact information for the issuer, underwriter, or other financial institution that can assist the investor with purchasing the bonds. Although the purchase of the bonds may require a brokerage account, it is a feature of the system that the user is not required to have a brokerage account to receive new issue information.

A feature of the system is that pre-submitted investor investment criteria can be continuously compared with the database of new issue information to identify interested investors and/or to identify updates to the new issue information.

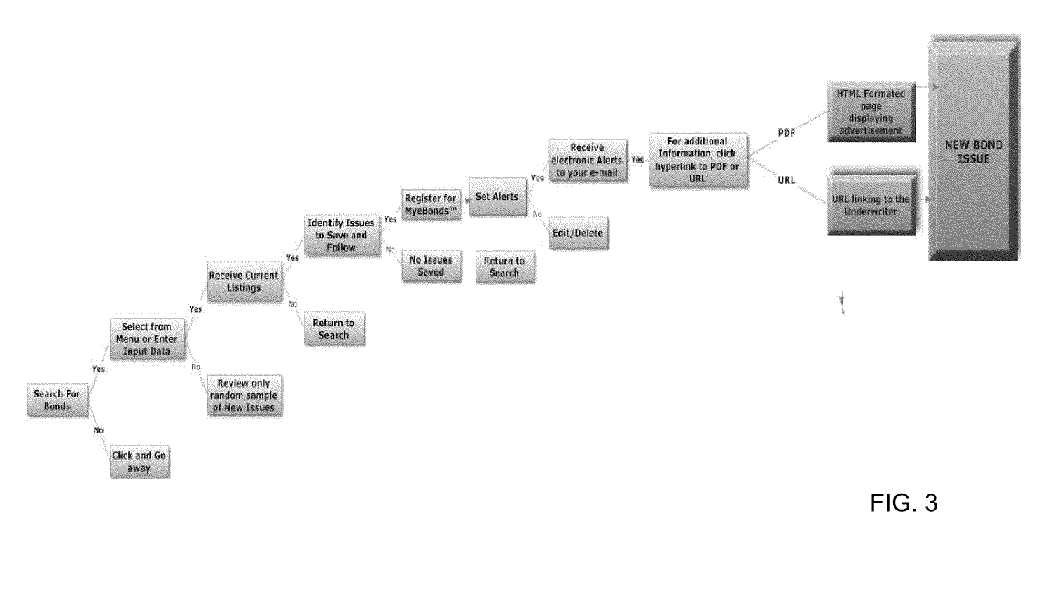

Investors can optionally receive updates regarding selected new issues as the pre-sale period progresses. The notices can include daily alerts that can be sent at a prearranged time each morning to investors at the investors' request. Alerts could also be according to another time period (bi-daily, weekly, etc.), or could be in real time as matching information is added to the database. FIGS. 3, 5, 7 and 8 schematically show how investors can receive alerts according to pre-selected alert settings.

New bond issues are subject to changes in offering details and disclosure information at any time prior to the final pricing. Changes can be regarding, without limitation: the pricing and yield; the coupon rate; maturities; sale date; order period times; and availability of the preliminary offering statement. The system allows notification of investors of such changes up to, and during, the actual bond sale. Notification can be by e-mail, telephone call, voicemail, text, or any other manner of social networking outlets such as Twitter or Facebook.

A feature of the system is to display, provide, and disseminate new issue information in a variety of ways to investors including periodic or real time notices, providing documents or hyperlinks to documents, providing hyperlinks to websites, and displaying scrolling temporary documents.

Some or all of the new issue information may be available to investors only after registration and/or via a subscription service. For investors, registration requires providing the information requested to receive authorization to receive additional information on upcoming bond issues. Registration would generally include confirmation of an e-mail address and selection of certain bond criteria that the investor may be interested in. Registered users can be provided a user ID and a password such that use of the invention is password protected. Various features of the invention can be offered selectively to registered users and withheld from non-registered users. For example, registered investors can be provided additional new issue information, can be allowed to search and sort new issue information according to additional criteria, and can be notified of new issue information that meets certain pre-selected criteria.

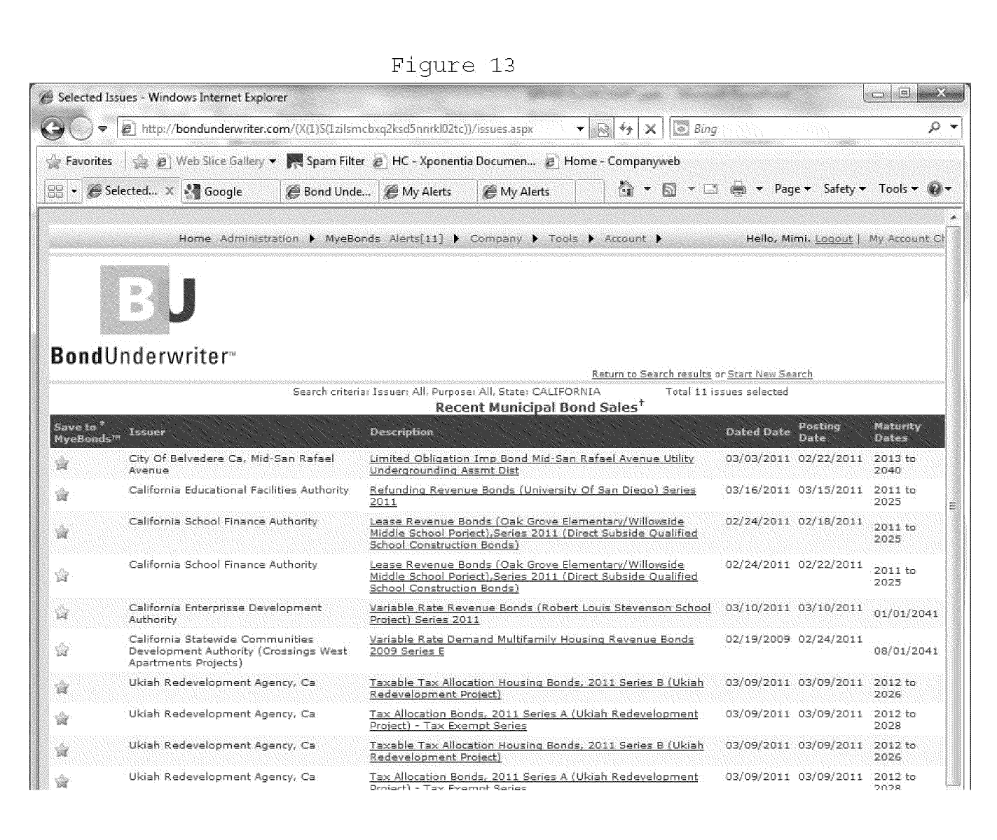

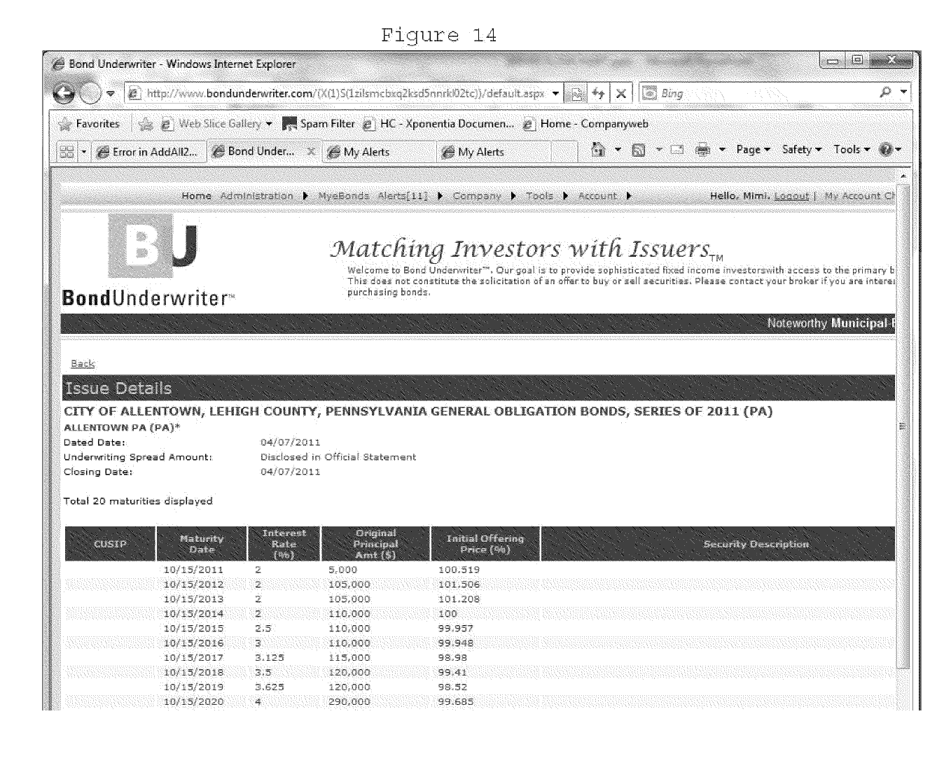

For recently sold bond issues, the investor can retrieve the final pricing and maturities by selecting the description of the issue as shown in FIGS. 13 and 14. The final official statement may also be available for review for post-sale bonds. This allows the investor to review final pricing and yield information after the successful sale and award of bonds, which assists investors in comparing and assessing new issues.

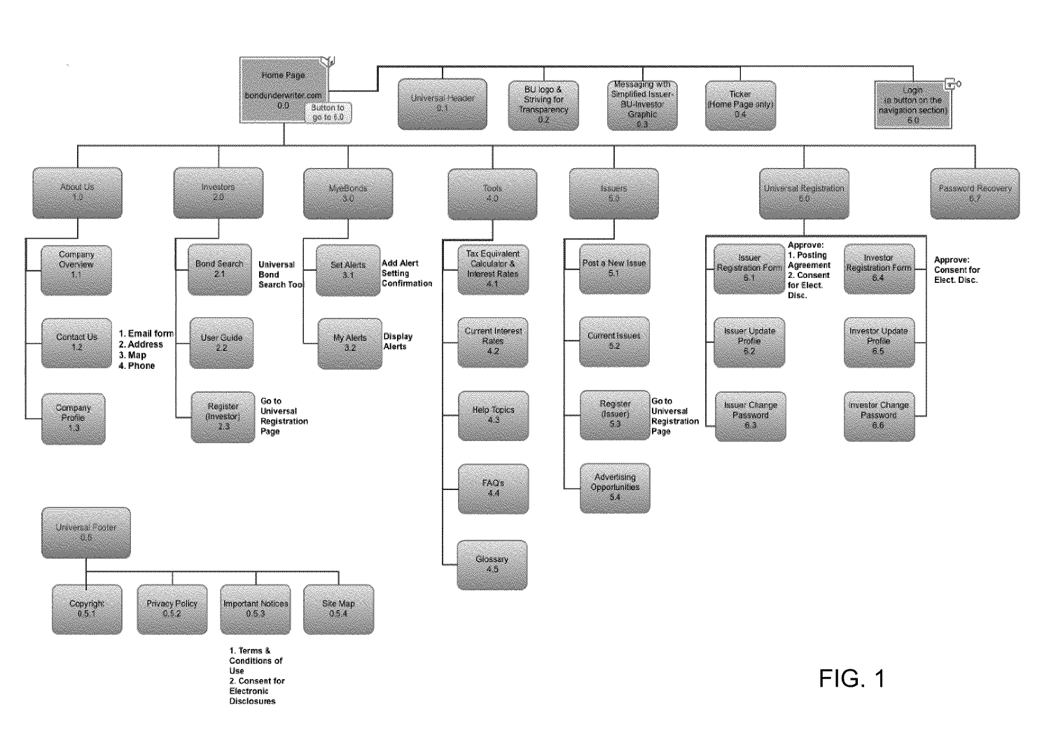

FIG. 1 is a website map schematically showing computer display interfaces that are part of the invention.

FIG. 3 is a schematic representing the way in which an investor would use the new issue information management system to identify new issue bonds and receive information regarding the new issue. As shown, the investor is given the option to search for new issue bonds. The investor identifies new issues according to various search criteria and is given the option to save selected issues and receive alerts regarding saved issues. In this embodiment, the investor registers prior to setting alerts for the selected new issues. Once an issue is identified, selected, saved, and set for alerts, additional information that may be subject of the alerts is accessible through the alert.

FIG. 4 is a schematic representation of the manner in which an issuer would post new issue information according to the system. As shown, an issuer registers by providing registration information, which is stored in a database with registration information from other issuers. The issuer posts a new issue by completing fields in an electronic interface. Completion of the fields can include the entry of data, selection from among given options such as in a drop down box, uploading documents, uploading data or databases, or providing URL links to relevant databases. Each field corresponds to specific information regarding the new issue and the inputted information is indexed in a database according to the field. The new issue information is stored in a database with other analogous information from other new issues and completed issues. The issuer may preview, edit, and approve the information submitted, after which the issue information is posted and available for search and selection by investors.

FIG. 5 illustrates in schematic form how issuers and investors use the system's database. Issuers populate a database according to a post new issue function and investors are notified of new issue information after search and selection of new issues of interest according to search criteria corresponding to information posted by the issuer. As shown schematically, alerts may also issue from the database to the investor.

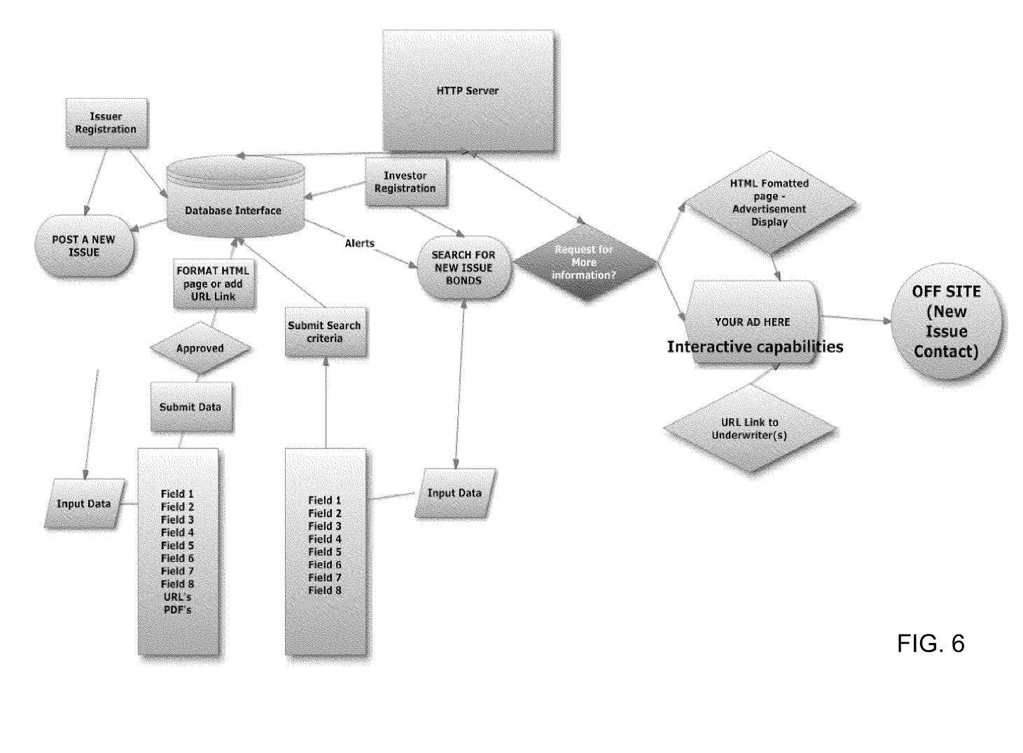

FIG. 6 illustrates in schematic form enhanced features available to investors and issuers, particularly the advertisement of new issues. Investors can be selectively provided with additional information or advertisements regarding new issues. As shown, investors can be directed to an advertisement sponsored by the issuer. Investors can also be directed to enhanced information including relevant URLs, documents, and contact information. The advertisement can be interactive in that the advertisement can be integrated into the user's search and review of new issue information.

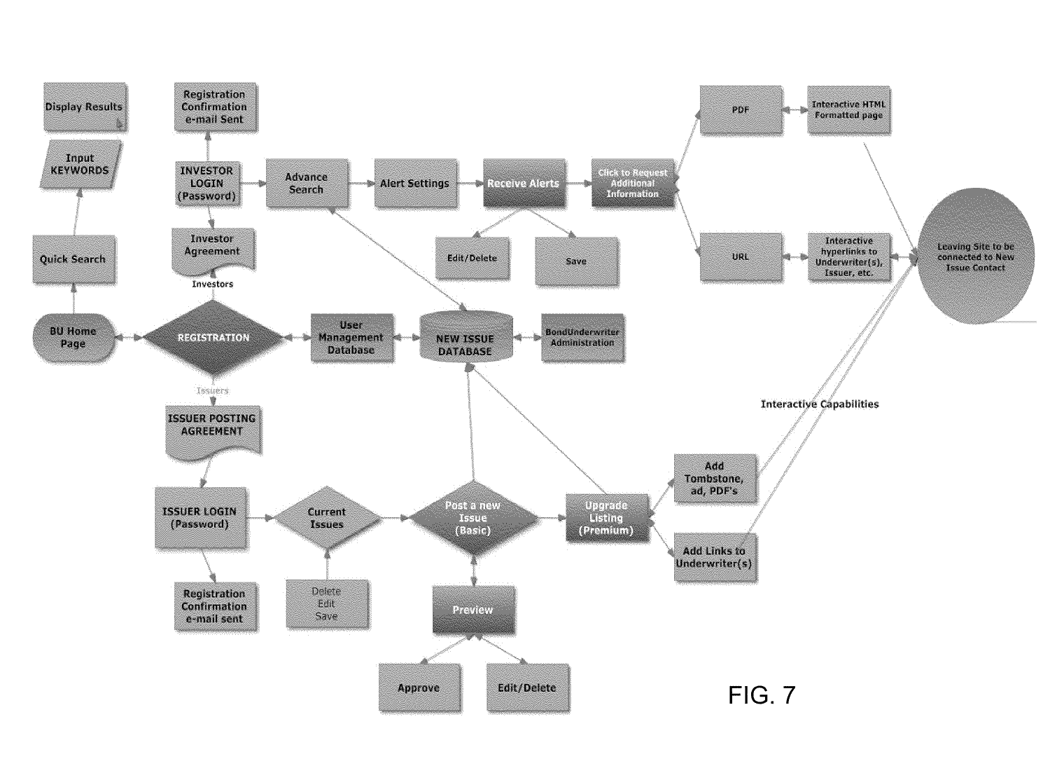

FIG. 7 illustrates in schematic form the interaction between investors and issuers. A new issue database is populated by issuers. The database is accessed and searched by investors, who select specific new issues of interest. Information posted by the issuers, including advertisements, is made available to the investors. The investor receives alerts regarding selected investments.

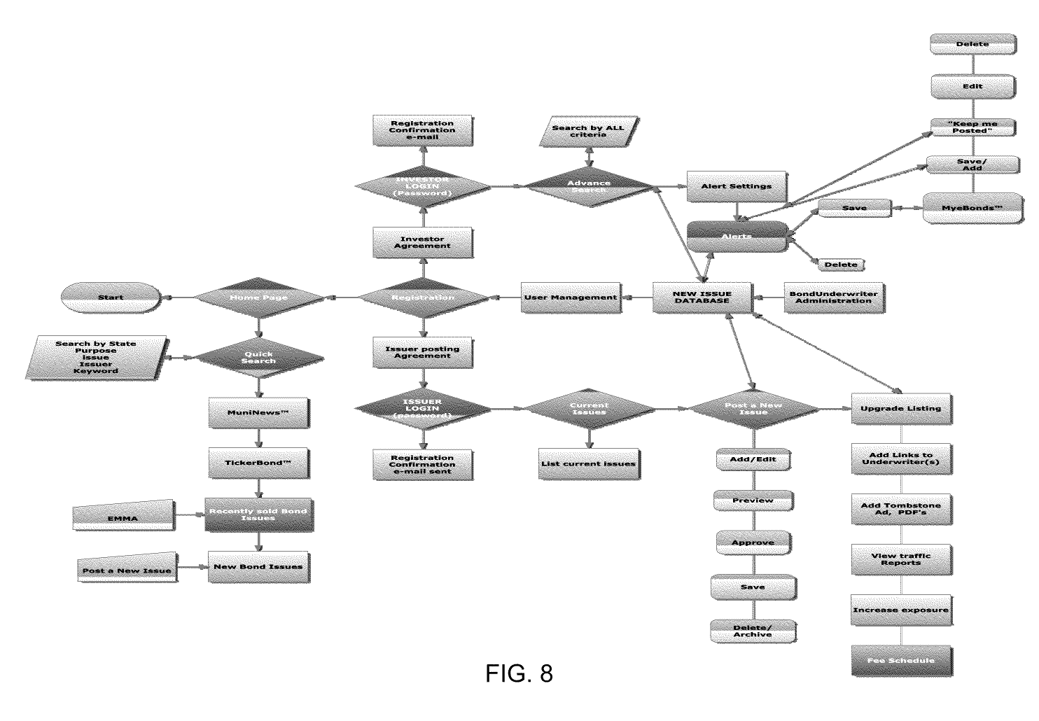

FIG. 8 is another schematic representation of the interaction between investors and issuers.

FIG. 9 is a schematic illustration of how new issue information posted by the issuer can correspond with the search criteria available to the investors. However, certain information posted by the issuer may not be a search metric. Also, certain search criteria may become available to the investor only after, for example, identification and selection of a new issue, or registration by the investor.

FIGS. 10-16 are a computer screen displays of the user interface of the system.

While the invention has been described with reference to one or more preferred embodiments those skilled in the art will understand that changes may be made and equivalents may be substituted without departing from the scope of the invention. In addition, many modifications may be made to adapt a particular step, structure, or system to the teachings of the invention without departing from its scope. Therefore, it is intended that the invention not be limited to the particular embodiment disclosed, but that the invention will include all embodiments falling within the scope of the appended claims.

1. A method of managing information related to new issue fixed income securities and characteristics of investor-sought securities by users of a management and information distribution system employing a computer system and a computer communication network, comprising:
entering into the computer system characteristics of new issue fixed income securities by a first user;
entering into the computer system characteristics of new issue fixed income securities sought by a second user;
comparing the characteristics entered by the first use with the characteristics sought by the second user;
identifying new issue fixed income securities that have the characteristics sought by the second user;
wherein the first and second user do not have a relationship with a common financial institution.

2. A method comprising:
receiving in a specifically programmed computer a request from a bond issuer to publish information relating to a new bond issue, the request including information regarding the issue;
receiving in the specifically programmed computer a request from an investor to identify new issue bonds with certain characteristics, the request including the sought after characteristics;
determining whether the investor's sought after characteristics are featured in the new issue bond that is the subject of the request from the bond issuer;
if the new issue bond does feature the sought after characteristics, identifying the new issue bond to the investor;
wherein the issuer and the investor do not have a relationship with a common financial institution.

3. A method comprising:
receiving information relating to multiple new issue bond offerings using a computer and a specifically programmed computer interface application that provides multiple fields regarding characteristics of new issue bonds, wherein the field are populated by issuers of new issue bond with information regarding new issue offerings;
translating, using a computer, the information relating to the new bond issues into a database;
creating on a computer screen a search interface for the database that is searchable by at least one of the characteristics corresponding to at least a first of the multiple fields populated by the issuers;
querying the database regarding the at least one characteristic and identifying and displaying on the computer screen new issue bond offerings in the database that feature the queried characteristic;
providing on a computer screen information regarding the identified new issue bond offering corresponding to the at least a second of the multiple fields populated by the issuers;
Wherein the new issue bond offerings are underwritten by various financial institutions or teams of financial institutions, and includes two or more new issue bond offerings wherein the underwriters are not identical and, if a team of underwriters, wherein the teams include no common members.
